(19) United States
(12) Patent Application Publication
(10) Pub. No.: US 2009/0067615 A1
(43) Pub. Date: Mar. 12, 2009

(54) ECHO CANCELLATION USING GAIN CONTROL

(75) Inventor: Malcom Strandberg, Cambridge, MA (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Aspect Software, Inc., Chelmsford, MA (US)

(21) Appl. No.: 11/853,299

(22) Filed: Sep. 11, 2007

(51) Int. Cl. H04M 9/08; H04B 3/20

(52) U.S. Cl. 379/406.01; 381/66

(57) ABSTRACT

A device for reducing echo by controlling microphone and/speaker gain in a telecommunications system is disclosed. An exemplary embodiment of the device may have an echo detector, echo level detector, and a gain controller. The echo detector detects an echo in a transmitted audio communication signal. The echo level detector determines the volume level of the detected echo. The gain control may adjust the gain of a microphone transmitting and/or speaker broadcasting the audio communication signal based on the echo level detected. The gain control and echo cancellation may cooperate with each other.

### TECHNICAL FIELD

The present invention relates to reducing echo in a telecommunications system and more specifically relates to reducing echo by controlling microphone gain in a telecommunications system.

### BACKGROUND INFORMATION

An echo results from the delay in a reflected audio signal. Most are familiar with the echo heard when an individual shouts across a valley. The echo is the sound wave reflecting back from the opposing valley wall (the reflection point), delayed by the distance the sound waves must travel back across the valley. The louder the original sound wave and further across the valley, i.e. the extra distance the reflected sound wave must travel, the more noticeable the echo will be. Humans generally will notice an echo with a delay exceeding twenty-five milliseconds (ms).

While an echo does not present a problem in open spaces, it is often unpleasant when heard in a communications system. Assume two people are having a conversation over a network. The network can be Internet Protocol, satellite, or another network type that may result in a delay. On the telephone there is an 80 ms or more (one-way) delay from the reflection point. This is equivalent to yelling across a valley. The individual would hear two different echoes of his own voice. One echo is the electrical echo that occurs at the transition from 2- to 4-wire cable, called a hybrid echo. The hybrid itself is typically located in the Central Office (CO) or another location, e.g. Private Branch Exchange (PBX). The hybrid is the reflection point of the electrical echo. Another echo involved in communication systems is the acoustic echo. The voice coming out of the loudspeaker bounces back from the wall to the microphone. The wall is the reflection point of the acoustic echo.

In the case of both electrical and acoustic echoes, the individual hears his own voice repeated with a delay. If an echo is encountered in the network, echo cancellation may be required. The echo canceller simulates the end echo path with a special algorithm. The signal that is reflected from the hybrid is subtracted from the calculated or simulated signal of the echo canceller. Ideally, the signal at the output of the echo canceller does not contain any echo. Another type of echo filter uses Non Linear Processing (NLP) to remove the echo portion. An NLP removes the audio segment when a user is not talking, similar to that heard on a walkie-talkie with noticeable breaks at the beginning and end of a conversation.

However, the above echo filters may not remove the echo. The echo tail-end delay is the time the voice needs to travel from the echo canceller to the hybrid and back. The tail-end delay can differ depending on the distance between the echo canceller and the hybrid, the quality of the hybrid (dispersion), and the acoustic echo. The capacity of an echo canceller may be limited by the echo tail-end delay (e.g., 64 ms). In addition, NLP filters present an unpleasing interruption between conversation and silence. NLP filters may lack the ability to handle interruptions. In a dialog it may be natural for a listener to interrupt the talker with a response prior to the talker completing the dialogue. The filter may not respond fast enough or may not respond adequately, thus cutting off dialogue of either the talker or listener. Accordingly, there is a need for an efficient system that reduces or limits echo in a communication system. The system may also reduce the echo tail-end delay without cutting off dialogue of a party involved in the communication. The system allows for far end audio and eliminates silence or noise fill providing more natural conversation. The system allows the echo detection and cancellation devices to communication and cooperates with audio gain controls.

### SUMMARY

Accordingly, the present invention is a novel system and device for reducing echo by controlling gain in a telecommunications system. An exemplary device may have an echo detector for detecting an echo in a transmitted audio communication signal. The exemplary device may also have an echo level detector for determining the volume level of the detected echo. The exemplary device also has a gain control for adjusting the gain of a microphone transmitting the audio communication signal and/or the gain of a speaker broadcasting the communication signal based on the echo level detected. The gain control may communicate and cooperate with echo cancellation devices.

Embodiments of the invention may have one or more of the following features. According to one exemplary embodiment, the gain may be reduced based on the echo level detected. In another embodiment, the gain may be reduced by increments of eight decibels based on the echo level detected. The exemplary device may also have a dynamic echo cancellation filter for reducing the echo introduced into the audio communication signal. In another embodiment, the device may have a dynamic echo cancellation filter for reducing the echo introduced into the audio communication signal and working in cooperation with the gain control. In yet another embodiment, the echo level detector and the gain control are housed within the telephone receiving the transmitted audio communication signal.

### BRIEF DESCRIPTION OF THE DRAWINGS

These and other features and advantages of the present invention will be better understood by reading the following detailed description, taken together with the drawings wherein:

FIG. 1 is a block diagram of a system implementing a VoIP adapter system within a contact center producing an echo, according to an exemplary embodiment of the present invention

FIG. 2A is a block diagram of a system implementing a VoIP adapter system within a contact center, according to an exemplary embodiment of the present invention;

FIG. 2B is a block diagram of a VoIP adapter, according to an exemplary embodiment of the present invention;

FIG. 3 is a block diagram of a system implementing a VoIP adapter system within a contact center, according to a second exemplary embodiment of the present invention

FIG. 4 is a functional block diagram of a wireless VoIP headset, according to an exemplary method embodiment of the present invention.

FIG. 5 is a functional block diagram of a wireless VoIP headset, according to a second exemplary method embodiment of the present invention.

### DETAILED DESCRIPTION

The echo reduction system of the present invention helps to reduce the disturbance caused by echo in a communication system. The invention reduces the gain of audio signal thereby reducing the volume of the transmitted echo. Often the volume of received audio is above a threshold needed for pleasant and effective communication. By reducing the volume, the parties may still effectively communicate without contributing to the disturbing effect of echo in the communication system. The echo reduction system may work in concert with other echo filter systems to minimize the echo heard and minimize the volume of any echo that cannot be filtered.

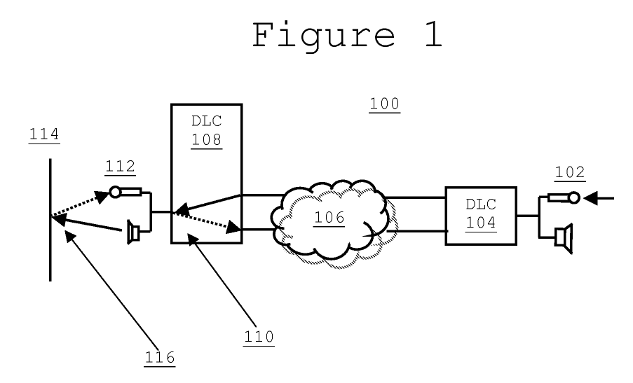

Referring to FIG. 1, a Voice Over Internet Protocol (VoIP) communication system 100 has a first station 102 with a microphone and a speaker. The microphone receives the audio and a first Digital Logic Converter (DLC) 104 converts the analog audio signal into digital packets that may be sent over a network 106. The network 106 may be, for example, an Internet Protocol (IP) network or other communications network. A second DLC 108 converts the digital packets back to an analog signal that may be used to broadcast over a speaker at a second station 112. The conversion at the second DLC 108 may introduce an electrical echo 110. The electrical echo is the audio signal reflected back and sent back to the first station 102. The electrical echo is treated as sound received from the second station and may be treated and amplified as legitimate communications from the second station 112.

A second source of echo may result from the audio broadcast by speaker of the second station 112 reflecting off a wall 114 or surface of the second station 112 and being picked up by a microphone of the second station 112. The reflected sound produces an acoustic echo that is picked up by the microphone. Again the acoustic echo may be treated and amplified as a legitimate communication from the second station 112.

Both acoustic echo and electrical echo may produce a disturbing effect to the listener at the first station 102. To reduce the echo effect, the invention reduces the incoming audio gain and/or outgoing audio gain on the side opposite the side receiving the echo. Therefore, the microphone gain and/or speaker gain may be reduced in station 102 to reduce the effects of the echo introduced in station 112.

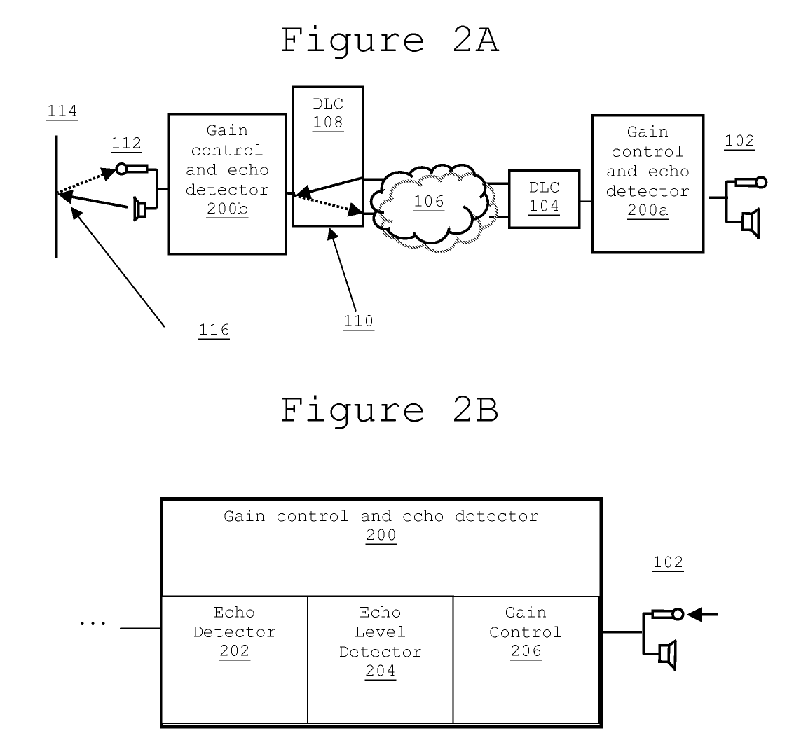

Referring to FIG. 2A, an exemplary system is shown with a gain control and an echo detector 200a located between the first station 102 and the first DLC 104 and a second gain control and an echo detector 200b located between the second station 112 and the second DLC 108. The communication is passed from the first station 102 to the second station 112 as previously described. As the communication is sent, electrical echo and acoustic echo may become mixed into the communication system. As the echoes are transmitted back to the first station 102, the gain control and echo detector 200a process the communication signal and echo.

Referring to FIG. 2B, the gain control and echo detector 200a and 200b may have an echo detector 202 that identifies the echo in the communication signal. The echo detector may use a previously stored control version of the communication signal that is subtracted from the communication signal to identify the echo or may use a simulated echo to match against the communication signal to separate the echo from the communication signal. Once the echo is identified or separated from the communication signal, an echo level detector 204 determines the level of the echo. If the echo is above a threshold level, the gain of the transmitted signal may be reduced. The threshold level may be a previously stored value that has been determined to interfere with normal conversation. The echo threshold level may be a dynamic level that takes into account various factors, for example, the current gain of a transmitted communication, the gain of a received communication, or other factors that may affect the interference resulting from the echo.

If the echo is determined to be above the desired threshold level, the gain of the communication signal is reduced. The reduction in the gain of the communication signal may be accomplished in increments. For example, the gain may be reduced by 4 decibels. If the echo is still above the desired level, the gain may be reduced again by 4 decibels. The total change would be 8 decibels in gain, which would not impair conversation of the users.

The current gain level may also be taken into consideration when deciding to reduce the gain if the echo is above the desired threshold. For example, the echo may be above the desired threshold, however, since the current gain barely meets a desired level for adequate communication, the gain may not be reduced even though the echo is above the threshold level. The gain adjusted by the system is not limited to the gain of the received audio from the microphone and/or speaker at the first station 102. The system may communicate adjustments to other devices that control gain of the signal within the communication path. For example, the system may control the gain of the received audio from the microphone at the second station 110 thereby reducing the effect of acoustic echo.

The system may adjust both microphone gain on the transmitting end and speaker gain on the receiving end. For example, if a large echo is detected, indicating the microphone gain is higher than needed, the microphone gain may be reduced. At the same time the speaker gain, on the end of the speaking user, may be reduced, as during the time the user is talking, it is not important to be able to clearly hear everything. However unlike non-linear processing audio transmission, the speaker may not be muted, just gain reduced, so that if the user at the other end needs to interrupt, their interruption will be heard (although attenuated). Once interrupted and the first user stops talking the system restores the gain of the transmitting users speaker and the other users audio again returns to as clear as possible transmission.

The system may use information about which user is speaking along with the detected echo levels at different points in transmission to determine which gain should be adjusted for microphones and speakers on both ends of the communication path. This allows for noise from echoes to be minimized while allowing for natural conversions with interruptions between users. The system may reduce gain on the microphone of the speaking user and reduce gain on the speaker of the speaking user to minimize gain. Once the speaking user ends talking and the other user begins speaking, the gains of the now silent user, formally speaking user, are return to prior levels and the now speaking user's microphone gain and speaker gains may be reduces to minimize echo effects.

The system is not limited to two-way conversions and may also be used in three or more way conversation. For example, the system may detect which of the three or more users is producing an echo and currently speaking and adjust the gain of the respective microphones and speakers for each of the three or more parties. The adjustment of gains levels may be predetermined or involve incremental adjustments based on successive detection of echo/noise levels.

The gain control and echo detector 200a and 200b may cooperate and communicate with each other to detect echo and adjust audio gain at various points along the signal path. The gain control and echo detector 200a and 200b may be implemented using hardware or software that is used to perform other functions on the communication signal. For example, the gain control and echo detector 200a and 200b may occur within the first DLC 104 or second DLC 108. Additional hardware or software may be implemented within the first DLC 104 or the second DLC 108 so that the first DLC 104 or the second DLC 108 not only processes the audio signal into digital packets but implements features of the invention described herein.

Processing and determination of gain adjustments may be accomplished on either or both ends of the communication path and communicated to equipment along the communication path. In one example, echo and noise detection may be performed by equipment on a specific end of the communication path without regard to which user is speaking. Gains adjustments may be determined by equipment on the specific end and communicated to equipment controlling the gain on the other end. The gain may be communicated by, for example, adjusting the gain within the transmitted signal protocol or communicating directly with an amplifying device on the other end of the communication path.

In another example, echo and noise detection may be performed by equipment on the listening user's end and communicated to the speaking user's end. Equipment on the speaking end may process the levels to determine adjustments to the microphone gain level equipment and adjustments to the speaker gain on the speaking end. When the listening user begins speaking the detection and processing may flip-flop. The system is not limited to the above example.

The gain control and echo detector 200a and 200b may also occur in a separate dedicated device. The device may have input and output ports, memory, a processor, amplifiers, and other components necessary to perform the function of the invention. The memory may store the threshold values and rules for adjusting the gain. The processor may implement the rules and causes components of the device to alter the communication signal based on the rules stored in memory.

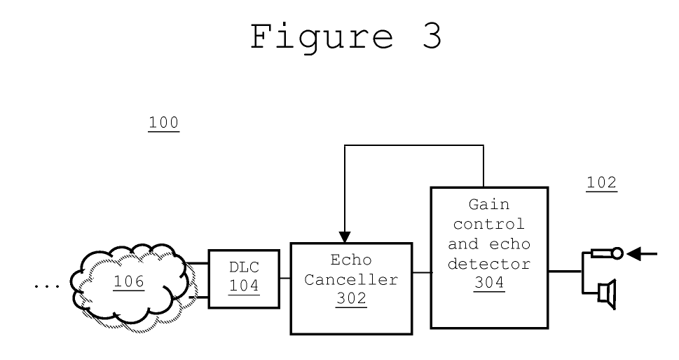

Referring to FIG. 3, a second exemplary embodiment of the invention allows the gain control and echo detector 304 to work in concert with an echo canceller 302. The gain control and echo detector 304 may communicate with the echo canceller 302 to efficiently facilitate removal and reduction of echo. For example, the echo canceller may isolate the echo and determine the level of the echo, which may then be communicated to the gain control and echo detector 304. In another example, the echo canceller may activate the gain control when the echo canceller is unable to remove the echo. For example, if the tail-end delay exceeds the limit of the echo canceller, the gain controller may be notified to determine if the gain of the signal may be reduced in order to reduce the interference of the echo.

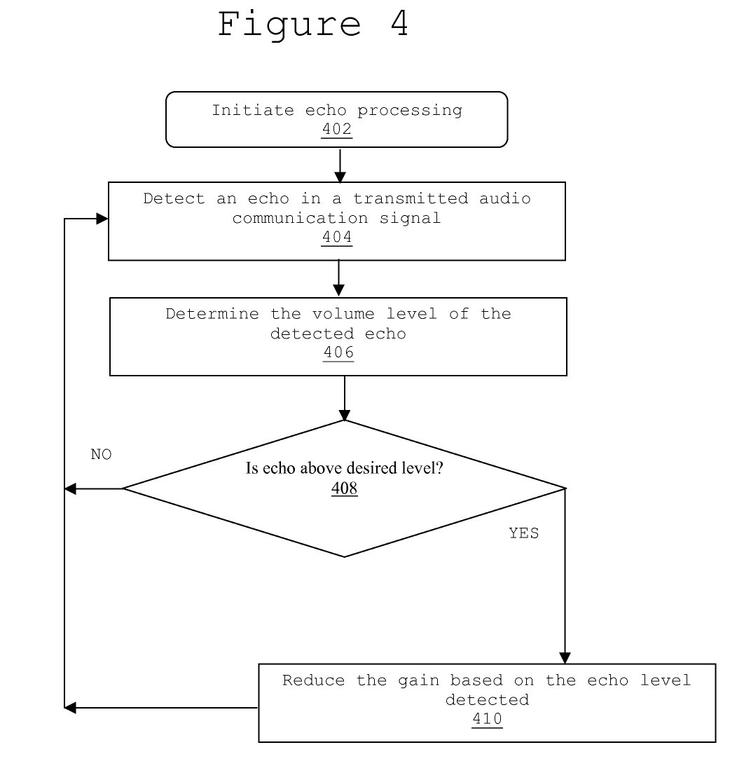

Referring to FIG. 4, an exemplary method may be implemented by the previously described hardware or other devices. The echo processing is initiated as communications are relayed between stations (block 402). The echo is identified from the audio communication signal (block 404). The echo may be identified using a variety of known techniques and as previously described herein. The level of the detected echo is determined (block 406). The process decides if the echo is above a desired level (block 408). As previously discussed, the invention may take into account a variety of factors when deciding if the echo is above a desired level. For example, the process may take into account if the current gain is above a threshold or if the gain may be reduced without having an adverse effect on communication of the parties.

If the echo is not above the desired level (“No” branch of block 408), the process continues to monitor the communication signal for echo levels above the desired value. If the echo is above the desired level (“Yes” branch of block 4080), the process may reduce the gain based on the detected echo levels (block 410). In another example, the process may take into account the gain imparted at multiple points along the communication path and adjust the gain at the points to better amplify the communication signal and not the echo. This may involve reducing the gain at one point in the communications path and communicating to another point in the communications path to increase the gain.

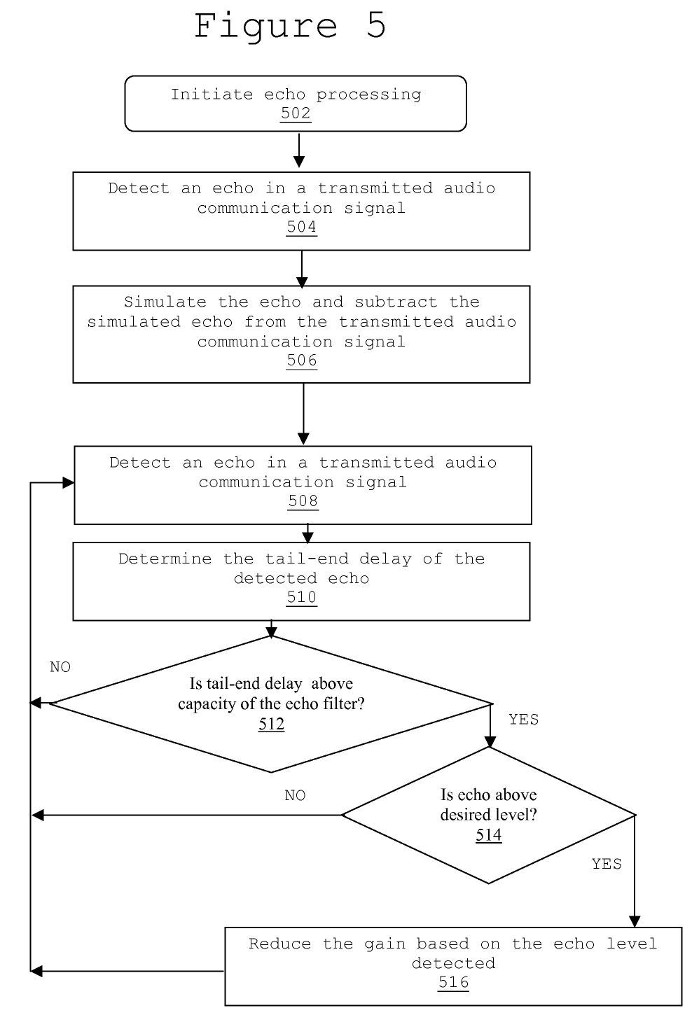

Referring to FIG. 5, a second exemplary method may be implemented by the previously described hardware or other devices that work in conjunction with an echo canceller. The echo processing is initiated as communications are relayed between stations (block 502). The echo is identified from the audio communication signal (block 504). This may be accomplished, for example, in an echo canceller or separate device that communicates the detected echo to both gain control and echo canceller. The echo canceller simulates the echo and subtracts the simulated echo from the transmitted audio communication signal (block 506). The echo may be identified using a variety of known techniques and as previously described herein. The echo may again be identified from the filtered audio communication signal (block 508). The process may determine if the tail-end delay of the detected echo or other aspects of the echo still remain (block 510). The process decides if the tail-end delay of echo was above the capacity of the filter or still interferes even after the echo has been filtered out (block 512).

If the aspects of the echo are not above the desired level or do not interfere (“No” branch of block 512), the process continues to monitor the communication signal for echo levels above the desired value. If the echo tail-end delay is beyond the capacity of the filter (“Yes” branch of block 512), the process may determine if the gain is above the desired echo levels (block 514). If the echo is not above the desired level (“No” branch of block 514), the process continues to monitor the communication signal for unfiltered echo and echo levels above the desired value. If the echo is above the desired level (“Yes” branch of block 514), the gain of the communication signal is reduced (block 516). The method reduces the echo by using cancellation techniques and reduces the interference of any portion of the echo that may not be filtered by the echo cancellation techniques.

The exemplary embodiments described herein can be implemented in digital electronic circuitry, or in computer hardware, firmware, software, or in combinations of them. The exemplary embodiments described herein can be implemented as a computer program product, i.e., a computer program tangibly embodied in an information carrier, e.g., in a machine-readable storage device or in a propagated signal, for execution by, or to control the operation of, communications processing apparatus, e.g., a processing device, a computer, or multiple computers. A computer program can be written in any form of programming language, including compiled, assembled, or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Modifications and substitutions by one of ordinary skill in the art are considered to be within the scope of the present invention, which is not to be limited except by the following claims.

The invention claimed is:

1. A device for reducing echo by controlling microphone and speaker gain in a telecommunications system comprising:
an echo detector for detecting an echo in a transmitted audio communication signal;
an echo level detector for determining the volume level of the detected echo; and
a gain control for adjusting the gain of a microphone transmitting the audio communication signal based on the echo level detected.

2. A device of claim 1, wherein the gain is reduced based on the echo level detected.

3. A device of claim 1, further comprising:
a gain control for adjusting the gain of a speaker on a transmitting end based on the echo level detected.

4. A device of claim 1, further comprises:
a dynamic echo cancellation filter for reducing the echo introduced into the audio communication signal.

5. A device of claim 1, further comprises:
a dynamic echo cancellation filter for reducing the echo introduced into the audio communication signal and working in cooperation with the gain control.

6. A device of claim 1, wherein the echo detector, the echo level detector, and the gain control are housed within the telephone receiving the transmitted audio communication signal.

7. A device of claim 1, wherein the echo is a hybrid echo and delay echo.

8. A method for reducing echo by controlling gain in a telecommunications system comprising the acts of:
detecting an echo in a transmitted audio communication signal;
determining the volume level of the detected echo; and
adjusting the gain of a microphone transmitting the audio communication signal based on the echo level detected wherein a gain control and an echo canceller cooperate with one another.

9. A method of claim 8, further comprising the act of:
adjusting the gain of a speaker on a transmitting end of the audio communication signal based on the echo level detected.

10. A method of claim 8, wherein the gain is reduced by increments of eight decibels based on the echo level detected.

11. A method of claim 8, further comprises:
removing echo introduced into the audio communication signal by dynamically filtering the audio communication signal.

12. A method of claim 8, further comprises:
removing echo introduced into the audio communication signal by dynamically filtering the audio communication signal; and
working in cooperation with the act of adjusting gain control.

13. A method of claim 8, wherein the echo detection and the echo level determination are performed within the telephone receiving the transmitted audio communication signal.

14. A method of claim 8, wherein the echo is a hybrid echo and delay echo.

15. A computer program product, tangibly embodied in an information carrier, for reducing echo by controlling microphone and speaker gain in a telecommunications system, the computer program product being operable to cause a machine to:
detect an echo in a transmitted audio communication signal;
determine the volume level of the detected echo; and
adjust the gain of a microphone transmitting the audio communication signal based on the echo level detected; and
adjusting the gain of a speaker on a transmitting end of the audio communication signal based on the echo level detected wherein a gain control and an echo canceller cooperate with one another.

16. A computer program product of claim 15, wherein the gain is reduced based on the echo level detected.

17. A computer program product of claim 15, wherein the gain is reduced by increments of eight decibels based on the echo level detected.

18. A computer program product of claim 15, further comprising to cause a machine to:
remove echo introduced into the audio communication signal by dynamically filtering the audio communication signal.

19. A computer program product of claim 15, further comprising to cause a machine to:
remove echo introduced into the audio communication signal by dynamically filtering the audio communication signal; and
work in cooperation with the act of adjusting gain control.

20. A computer program product of claim 15, wherein the echo detection and the echo level determination are performed within the telephone receiving the transmitted audio communication signal.
